(19) United States
(12) Patent Application Publication
(10) Pub. No.: US 2022/0084304 A1
(43) Pub. Date: Mar. 17, 2022

(54) METHOD AND ELECTRONIC DEVICE FOR IMAGE PROCESSING

(71) Applicant: Beijing Dajia Internet Information Technology Co., Ltd., Beijing (CN)

(72) Inventors: Mading LI, Beijing (CN); Yunfei Zheng, Beijing (CN); Jiajie Zhang, Beijing (CN); Xiaodong Ning, Beijing (CN); Yuyan Song, Beijing (CN); Bing Yu, Beijing (CN)

(21) Appl. No.: 17/532,319

(22) Filed: Dec. 7, 2021

Related U.S. Application Data
(63) Continuation of application No. PCT/CN2020/075767, filed on Feb. 18, 2020.

(30) Foreign Application Priority Data
May 22, 2019 (CN) 201910433470.X

(51) Int. Cl. G06V 10/25; G06V 20/00; G06V 10/46; G06V 10/28; G06V 10/762; G06T 3/40; G06T 3/20; G06T 7/11

(52) U.S. Cl. CPC G06V 10/25; G06V 20/00; G06V 10/462; G06V 10/28; G06V 2201/07; G06T 3/40; G06T 3/20; G06T 7/11; G06T 2207/20132; G06V 10/762

(57) ABSTRACT

An method for image processing, an apparatus (500) for image processing and an electronic device (600) are disclosed. The method includes: determining a target area in an image by detecting the image, the target area corresponds to a target image meeting a pre-set condition, and the image comprises the target image; determining a point of interest of the image according to the target area; and processing the image according to the point of interest.

### CROSS REFERENCE TO RELATED APPLICATIONS

This application is the continuation application of International Application No. PCT/CN2020/075767, filed on Feb. 18, 2020, which is based upon and claims priority to Chinese Patent Application No. 201910433470.X, entitled “METHOD AND APPARATUS, AND ELECTRONIC DEVICE FOR IMAGE PROCESSING”, and filed to the China National Intellectual Property Administration on May 22, 2019, the entire contents of which are incorporated herein by reference.

### FIELD

The disclosure relates to the field of the Internet, in particular to a method and apparatus, and an electronic device for image processing.

### BACKGROUND

In related art, with the rapid development of the Internet, image-based applications emerge in an endless stream, and users have an increasing demand for image editing and processing in various aspects, such as cropping, zooming, translation, or rotating of images; and generally, when an image is edited, a default center point is a center point of the image, that is, the image is cropped, zoomed, translated, or rotated based on the position of the center point of the image.

### SUMMARY

The present disclosure provides a method and apparatus, and an electronic device for image processing.

In a first aspect, some embodiments of the present disclosure provide a method for image processing. The method includes: determining a target area in an image by detecting the image, the target area corresponds to a target image meeting a pre-set condition, and the image includes the target image; determining a point of interest of the image according to the target area; and processing the image according to the point of interest.

In a second aspect, some embodiments of the disclosure provide an apparatus for image processing. The apparatus includes: a detecting unit, configured to determine a target area in an image by detecting the image, the target area corresponds to a target image meeting a pre-set condition, and the image includes the target image; a determining unit, configured to determine a point of interest of the image according to the target area; and an executing unit, configured to process the image according to the point of interest.

In a third aspect, some embodiments of the disclosure provide an electronic device for image processing. The electronic device includes: a processor; and a memory configured to store executable instructions of the processor; the processor is configured to determine a target area in an image by detecting the image, wherein the target area corresponds to a target image meeting a pre-set condition, and the image comprises the target image; determine a point of interest of the image according to the target area; and process the image according to the point of interest.

In a fourth aspect, some embodiments of the disclosure provide a storage medium is provided. When instructions in the storage medium are executed by a processor of an image processing electronic device, the electronic device can execute the image processing method as described in the first aspect.

In fifth aspect, some embodiments of the disclosure provide a computer program product including instructions is provided. When the computer program product runs on a computer, the computer can execute the image processing method as described in the first aspect and any one of optional modes of the first aspect.

It should be understood that the above general descriptions and the following detailed descriptions are exemplary and explanatory only, and are not intended to limit the disclosure.

### BRIEF DESCRIPTION OF THE DRAWINGS

The accompanying drawings, which are incorporated in and constitute a part of this specification, illustrate embodiments consistent with the disclosure and together with the specification serve to explain the principles of the disclosure.

FIG. 1 is a flowchart of a method for image processing according to embodiments of the disclosure.

FIG. 2 is a flowchart of a method for image processing according to embodiments of the disclosure.

FIG. 3 is a flowchart of a method for image processing according to embodiments of the disclosure.

FIG. 4 is a flowchart of a method for image processing according to embodiments of the disclosure.

FIG. 5 is a structural block diagram of an apparatus for image processing according to embodiments of the disclosure.

FIG. 6 is a structural block diagram of an electronic device according to embodiments of the disclosure.

### DETAILED DESCRIPTION OF THE EMBODIMENTS

In order to enable those ordinarily skilled in the art to better understand the technical solutions of the disclosure, the technical solutions in the embodiments of the disclosure will be described clearly and completely with reference to the accompanying drawings.

It should be noted that the terms “first” and “second” in the specification and claims of the disclosure and the above-mentioned accompanying drawings are used to distinguish similar objects, and are not necessarily used to describe a specific sequence or precedence order. It should be understood that data used in this way may be interchanged under appropriate circumstances, so that the embodiments of the disclosure described herein may be implemented in a sequence other than those illustrated or described herein. The implementations described in the following exemplary embodiments do not represent all implementations consistent with the disclosure. On the contrary, they are merely examples of apparatuses and methods consistent with some aspects of the disclosure as detailed in the appended claims.

The embodiments of the disclosure may be applied to mobile terminals, which specifically may include, but are not limited to: smart phones, tablet computers, e-book readers, Moving Picture Experts Group Audio Layer III (MP3) players, Moving Picture Experts Group Audio Layer IV (MP4) players, laptop portable computers, car computers, desktop computers, set-top boxes, smart TVs, wearable devices, smart speakers and so on.

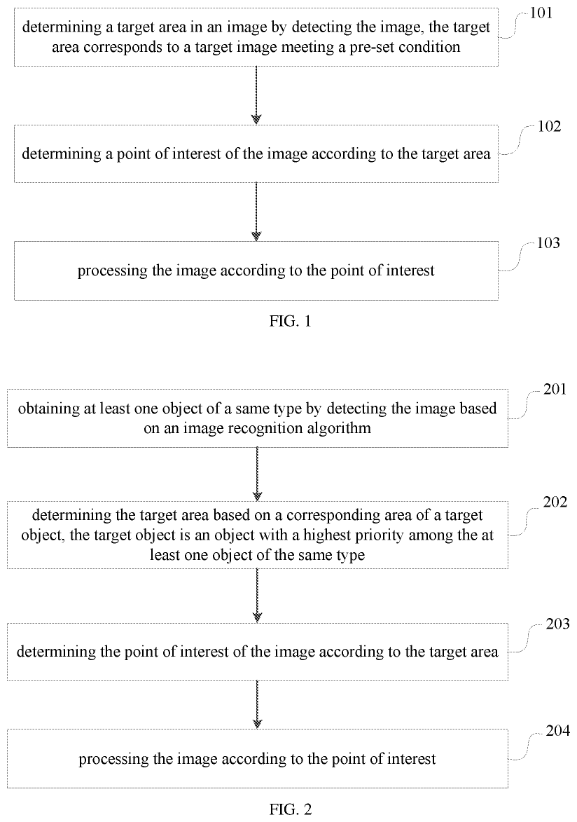

FIG. 1 is a flowchart of a method for image processing according to the embodiments of the disclosure. As shown in FIG. 1, the method is applied to a terminal and includes the following steps:

101, determining a target area in an image by detecting the image, the target area corresponds to a target image meeting a pre-set condition, and the image includes the target image.

It should be understood that the image is detected and filtered based on the pre-set condition, the target image meeting the condition is filtered out, and the target area is determined based on the corresponding area of the target image. Exemplarily, in a photo with a plurality of face images, the face image closest to a lens and with a highest definition may be, but not limited to, filtered out based on the pre-set condition, and the target area is determined based on an image area corresponding to the face image.

The method further includes: 102, determining a point of interest of the image according to the target area.

Exemplarily, when the target area is determined, the point of interest of the image may be determined based on a geometric center point of the target area. For example, when the target area is determined to be the face image, the point of interest may be, but not limited to, determined according to the position of a nose.

In some embodiments, after the target area is determined, the point of interest may be determined in an area outside the target area. For example, if an area corresponding to a face image with a smallest area in a certain photo is determined as the target area, the point of interest may be determined based on the area corresponding to the face outside the target area.

Exemplarily, when the target area is determined, the point of interest of the image may be determined based on a pre-set feature point of the target area. For example, when the target area is determined to be the face image, eyes of the face image are further detected and then determined as the point of interest of the image, that is, when the target area is a human face, the pre-set feature point may be, but not limited to, the human eyes.

The method further includes: 103, processing the image according to the point of interest.

Exemplarily, when the image is edited, the position of an operation point may be determined based on the position of the point of interest. For example, the point of interest may be determined as a cropping center, a rotation center, a zooming center or a translation center, etc., which is not specifically limited; and then subsequent editing processing is performed on the image according to the determined operation point.

Exemplarily, the method may be applied to both the process of editing images and the process of processing video frames, and not only applied to manual editing operations by users, but also applied to algorithm automatic editing and editing processes, which is not specifically limited.

The method for image processing is provided. Through the method, the target area corresponding to the target image, meeting the pre-set condition, in the image is determined, the image includes the target image, the point of interest of the image is determined according to the target area, and then the image is processed according to the point of interest, so that the point of interest of a user can be intelligently matched; and the point of interest may be configured to determine the position of the operation point during subsequent editing of the image, and the user does not need to manually adjust the operation point any more, thereby meeting the actual requirements of the user, and improving the efficiency of the image processing.

FIG. 2 is a flowchart of a method for image processing according to the embodiments of the disclosure. As shown in FIG. 2, the method for processing the image is applied to a terminal and includes the following steps:

201, obtaining at least one object of a same type by detecting the image based on an image recognition algorithm.

202, determining the target area based on a corresponding area of a target object, the target object is an object with a highest priority among the at least one object of the same type.

Exemplarily, object detection is performed on the image based on the image recognition algorithm. For example, the at least one face image can be obtained by detecting the face images in the photo. Exemplarily, when only one face image is detected in the photo, the area of the face image is determined to be the target area; when it is detected that more than two face images exist, the target area may be, but not limited to, determined based on the area size occupied by each of the face images, that is, the face image that occupies the largest area among the face images is determined as the target area; when it is detected that a plurality of face images occupy the same area, further detection may be performed. Exemplarily, judgment may be further performed based on clarity, positions and the like; and when it is detected that no face image exists, the target image is determined according to other pre-set rules.

Generally, the point of interest of the user is on the object with the largest area and the highest definition, but the object is not always in the center of the entire image. If the above-mentioned object with the largest area and the highest definition is determined as the point of interest, subsequent operations are performed on the image based on the point of interest. Therefore, the point of interest of the user may be intelligently matched, and the user's operations are facilitated.

In some embodiments, the target objects can be prioritized based on the corresponding area size, clarity, color vividness, target detection confidence score, etc. of the target object, and then the target area is determined based on the area corresponding to the object with the highest priority.

The method further includes: 203, determining the point of interest of the image according to the target area.

In some embodiments, the determining the point of interest of the image according to the target area, includes: determining the point of interest of the image based on a center point of the target area; or determining the point of interest of the image based on any pre-set feature point of the target area.

It should be understood that after the target area is determined, it is also necessary to determine the point in the target area as the point of interest according to other rules. Optionally, the position center point of the target area may be determined as the point of interest, or a certain pre-set feature point is selected as the point of interest; and exemplarily, when the target area is a face image, a nose tip of the face image may be determined as the point of interest, or a brow center of the face image may also be determined as the point of interest, and the rules may be adjusted according to the demands of the user, which is not specifically limited.

The method further includes: 204, processing the image according to the point of interest.

In some embodiments, the processing the image according to the point of interest, includes:

determining a cropping range according to the point of interest; and cropping the image according to the cropping range; or

determining a zooming center according to the point of interest; and zooming the image according to the zooming center; or

determining a translation start point and a translation end point according to the point of interest; and translating the image according to the translation start point and the translation end point.

Exemplarily, the cropping range may be determined according to the point of interest when the image is cropped, the point of interest is determined as an operation center of a cropping operation, and the user can conveniently crop an important part according to the point of interest.

Exemplarily, the zooming center is determined according to the point of interest when the image is zoomed, the target area is scaled in equal proportions around the point of interest, the user does not need to manually adjust a zooming center position, and operations by the user are facilitated.

Exemplarily, the translation end point may be determined based on the point of interest when the image is translated. Accordingly, the point of interest may be translated to the end point position to complete a translation operation.

Exemplarily, various editing operations such as blurring, rotating, and color adjustment may be performed on the image based on the point of interest, which is not specifically limited.

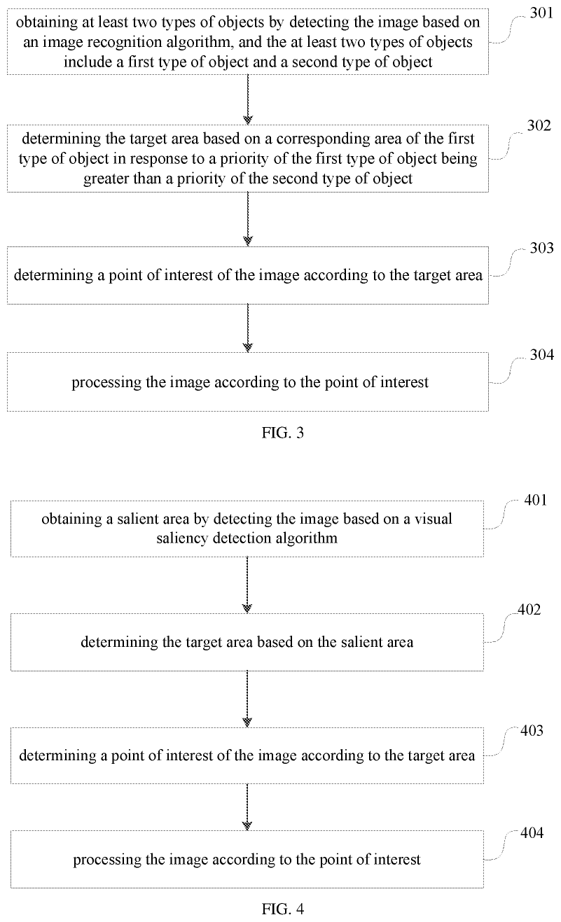

FIG. 3 is a flowchart of a method for image processing according to the embodiments of the present disclosure. As shown in FIG. 3, the method for processing the image is applied to a terminal and includes the following steps:

301: obtaining at least two types of objects by detecting the image based on an image recognition algorithm, and the at least two types of objects include a first type of object and a second type of object.

302: determining the target area based on a corresponding area of the first type of object in response to a priority of the first type of object being greater than a priority of the second type of object.

It should be understood that when object detection is performed on the image according to the image recognition algorithm, a plurality of types of objects may be detected out, for example, human figures, animals, or plants are detected out; and optionally, different types of objects may be prioritized, and then the target object is determined based on a priority order.

In some embodiments, it may be determined that the priority order is that human figures are higher than animals, and animals are higher than plants. For example, when the image is recognized, a dog, a human face, and a tree are recognized, the human face is determined to be the target object, and an area corresponding to the human face is the target area; for another example, when the image is recognized and only a dogs, a tree, and a flower are recognized, the dog are determined as the target object, and an area corresponding to the dog is the target area.

In some embodiments, different types of objects may be filtered first, and then areas occupied by objects of the same type may be judged. Exemplarily, when the human faces, the dogs, and the trees are detected out in the image, the objects may be sorted according to the priority of the different types of objects, and a plurality of face images are filtered first. Then the largest face is selected from the plurality of face images as the target object, and the area occupied by the largest face is determined as the target area.

In some embodiments, the areas occupied by the objects may be judged first, and then different types of objects are filtered. Exemplarily, the objects whose area exceeds a threshold may be filtered first, and then the filtered objects may be prioritized. For example, when there are a human face, a dog, and a tree in the detected image, the area of the human face, the area of the dog and the area of the tree are first judged, and the dog with a large area and the tree with a large area are selected, and then the dog and tree are prioritized again, and finally the dog is determined as the target object and the area occupied by the dog is determined as the target area.

The method further includes; 303, determining a point of interest of the image according to the target area; and 304, processing the image according to the point of interest.

For 303 and 304, reference may be made to the description of 203 and 204 in the embodiment shown in FIG. 2, which will not be repeated here.

FIG. 4 is a flowchart of a method for image processing according to the embodiments of the disclosure. As shown in FIG. 4, the method for image processing is applied to a terminal and includes the following steps:

401, obtaining a salient area by detecting the image based on a visual saliency detection algorithm.

In one possible implementation, the obtaining a salient area by detecting the image based on a visual saliency detection algorithm, includes:

obtaining gray values corresponding to different areas in the image by detecting the image based on the visual saliency detection algorithm; and determining the salient area based on a first area corresponding to a first gray value, the first gray value is within a pre-set gray value range.

It may be understood that when determining the target area, the saliency detection may be performed on the image based on the visual saliency detection algorithm to obtain a grayscale image corresponding to the image and with the same size (or equal scale reduction) as an input image, the grayscale image uses different grayscales to indicate different saliency degrees, and then the salient area and an insignificant area of the image are determined based on the grayscale image.

The method further includes:

402, determining the target area based on the salient area; and

403, determining a point of interest of the image according to the target area.

In one possible implementation, the determining the point of interest of the image according to the target area, includes:

obtaining a binary image corresponding to the salient area by binarizing the salient area; and determining the point of interest of the image based on a center of gravity of the binary image; or

obtaining cluster centers corresponding to the salient area by performing cluster analysis on the salient area; and determining the point of interest of the image based on a cluster center with a highest saliency degree among the cluster centers.

Binarization processing is performed on the image, that is, grayscale images of different brightness levels are selected through appropriate thresholds, so as to obtain a binary image that may still reflect the overall and local characteristics of the image, so that the entire image appears an obvious black and white effect. Because the image binarization can greatly reduce the amount of data in the image, the contour of a target can be highlighted, and then the center of gravity is calculated based on the binary image and used as the point of interest of the image.

In some embodiments, the position center of the salient area may also be used as the point of interest, or the point of interest may be determined based on the gray value of the salient area, which is not specifically limited.

Cluster analysis refers to the analysis process of grouping a set of objects into a plurality of classes composed of similar objects, and the purpose is to collect data on the basis of similarity to classify; in the present disclosure, cluster analysis may be used to perform image segmentation, that is, to segment parts with different attributes and characteristics, and extract the parts that the user is interested in; and therefore, a plurality of cluster centers of the image may be obtained, and a cluster center with a highest saliency degree is determined as the point of interest of the image.

The method further includes: 404, processing the image according to the point of interest.

In some embodiments, when the image is cropped, the cropping range is determined according to the point of interest, and then the image is cropped based on the cropping range; or when the image is zoomed, the point of interest is determined to be a zooming center, then the image is zoomed based on the position of the point of interest; or when the image is translated, the translation end point is determined based on the point of interest, and then the image is translated based on the position of the translation end point.

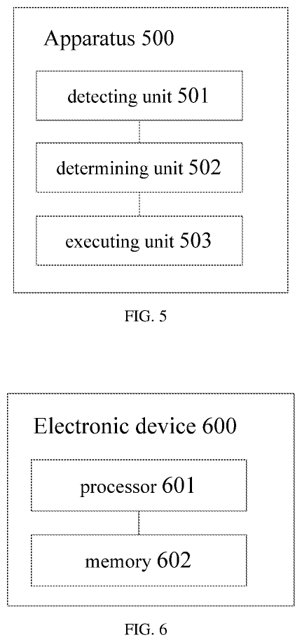

FIG. 5 is a structural block diagram of an apparatus 500 for image processing according to the embodiments of the disclosure. Referring to FIG. 5, the apparatus includes a detecting unit 501, a determining unit 502 and an executing unit 503.

The detecting unit 501 is configured to determine a target area in an image by detecting the image, the target area corresponds to a target image meeting a pre-set condition, and the image includes the target image.

The determining unit 502 is configured to determine a point of interest of the image according to the target area.

The executing unit 503 is configured to process the image according to the point of interest.

The embodiments of the disclosure provide the image processing apparatus 500. Through the method, the image is detected, the target area corresponding to the target image, meeting the pre-set condition, in the image is determined, the image includes the target image, the point of interest of the image is determined according to the target area, and then the image is processed according to the point of interest, so that the point of interest of the user can be intelligently matched, the point of interest is configured to determine the position of an operation point during subsequent editing of the image, and the user does not need to manually adjust the operation point any more, thereby meeting the actual requirements of the user, and improving the experience of the user.

In one possible implementation, the detecting unit 501 is further configured to obtain at least one object of a same type by detecting the image based on an image recognition algorithm; and determine the target area based on a corresponding area of a target object, the target object is an object with a highest priority among the at least one object of the same type.

In one possible implementation, the detecting unit 501 is further configured to obtain at least two types of objects by detecting the image based on an image recognition algorithm, the at least two types of objects comprise a first type of object and a second type of object; and determine the target area based on a corresponding area of the first type of object in response to a priority of the first type of object being greater than a priority of the second type of object.

In one possible implementation, the determining unit 502 is further configured to determine the point of interest of the image based on a center point of the target area; or determine the point of interest of the image based on any pre-set feature point of the target area.

In one possible implementation, the detecting unit 501 is further configured to obtain a salient area by detecting the image based on a visual saliency detection algorithm; and determine the target area based on the salient area.

In one possible implementation, the detecting unit 501 is further configured to obtain gray values corresponding to different areas in the image by detecting the image based on the visual saliency detection algorithm; and determine the salient area based on a first area corresponding to a first gray value, and the first gray value is within a pre-set gray value range.

In one possible implementation, the determining unit 502 is further configured to:

obtain a binary image corresponding to the salient area by binarizing the salient area; and determine the point of interest of the image based on a center of gravity of the binary image; or

obtain cluster centers corresponding to the salient area by performing cluster analysis on the salient area; and determine the point of interest of the image based on a cluster center with a highest saliency degree among the cluster centers.

In one possible implementation, the executing unit 503 is further configured to:

determine a cropping range according to the point of interest; and crop the image according to the cropping range; or

determine a zooming center according to the point of interest; and zoom the image according to the zooming center; or

determine a translation start point and a translation end point according to the point of interest; and translate the image according to the translation start point and the translation end point.

Regarding the apparatus 500 in the above-mentioned embodiments, the specific manners in which each unit performs operations have been described in detail in the embodiments related to the method, and detailed description will not be given here.

FIG. 6 is a structural block diagram of an electronic device 600 according to the embodiments of the disclosure. Referring to FIG. 6, the electronic device 600 includes a processor 601 and a memory 602 configured to store executable instructions of the processor 601.

The processor 601 is configured to perform the following process:

determining a target area in the image by detecting the image, the target area corresponds to a target image meeting a pre-set condition, and the image includes the target image;

determining a point of interest of the image according to the target area; and

processing the image according to the point of interest.

In one possible implementation, the processor 601 is configured to:

obtain at least one object of a same type by detecting the image based on an image recognition algorithm e; and

determine the target area based on a corresponding area of a target object, the target object being an object with a highest priority among the at least one object of the same type.

In one possible implementation, the processor 601 is configured to:

obtain at least two types of objects by detecting the image based on an image recognition algorithm, and the at least two types of objects includes a first type of object and a second type of object; and

determine the target area based on a corresponding area of the first type of object in response to a priority of the first type of object being greater than a priority of the second type of object.

In one possible implementation, the processor 601 is configured to:

determine the point of interest of the image based on a center point of the target area; or

determine the point of interest of the image based on any pre-set feature point of the target area.

In one possible implementation, the processor 601 is configured to:

obtain a salient area by detecting the image based on a visual saliency detection algorithm; and

determining the target area based on the salient area.

In one possible implementation, the processor 601 is configured to:

obtain gray values corresponding to different areas in the image by detecting the image based on the visual saliency detection algorithm; and

determine the salient area based on a first area corresponding to a first gray value, wherein the first gray value is within a pre-set gray value range.

In one possible implementation, the processor 601 is configured to:

obtain a binary image corresponding to the salient area by binarizing the salient area; and determine the point of interest of the image based on a center of gravity of the binary image; or

obtain cluster centers corresponding to the salient area by performing cluster analysis on the salient area; and determine the point of interest of the image based on a cluster center with a highest saliency degree among the cluster centers.

In one possible implementation, the processor 601 is configured to:

determine a cropping range according to the point of interest; and crop the image according to the cropping range; or

determine a zooming center according to the point of interest; and zoom the image according to the zooming center; or

determine a translation start point and a translation end point according to the point of interest; and translate the image according to the translation start point and the translation end point.

In some embodiments, a storage medium including instructions is further provided, such as a memory including instructions, and the instructions may be executed by a processor to complete the above-mentioned method. In some embodiments, the storage medium may be a non-transitory computer-readable storage medium, for example, the non-transitory computer-readable storage medium may be a ROM, a random access memory (RAM), a CD-ROM, a magnetic tape, a floppy disk, and an optical data storage device, etc.

In some embodiments, an application program/computer program product is further provided, which includes one or a plurality of instructions that may be executed by a processor to complete the above-mentioned image processing method. The method includes: determining a target area in the image by detecting the image, the target area corresponds to a target image meeting a pre-set condition, and the image includes the target image; determining a point of interest of the image according to the target area; and processing the image according to the point of interest. In some embodiments, the above-mentioned instructions may also be executed by the processor to complete other steps involved in the above-mentioned exemplary embodiments.

Other embodiments of the disclosure will be apparent to those skilled in the art from consideration of the specification and practice of the disclosure herein. The disclosure is intended to cover any variations, uses, or adaptations of the disclosure following the general principles thereof and including such departures from the disclosure as come within known or customary practice in the art. It is intended that the specification and embodiments be considered as exemplary only, with a true scope and spirit of the disclosure being indicated by the following claims.

It should be understood that the disclosure is not limited to the exact construction that has been described above and illustrated in the accompanying drawings, and that various modifications and changes may be made without departing from the scope thereof. It is intended that the scope of the disclosure only be limited by the appended claims.

What is claimed is:

1. A method for image processing, comprising:
determining a target area in an image by detecting the image, wherein the target area corresponds to a target image meeting a pre-set condition, and the image comprises the target image;
determining a point of interest of the image according to the target area; and
processing the image according to the point of interest.

2. The method according to claim 1, wherein said determining the target area in the image by detecting the image, comprises:
obtaining at least one object of a same type by detecting the image based on an image recognition algorithm; and
determining the target area based on a corresponding area of a target object, wherein the target object is an object with a highest priority among the at least one object of the same type.

3. The method according to claim 1, wherein said determining the target area in the image by detecting the image, comprises:
obtaining at least two types of objects by detecting the image based on an image recognition algorithm, wherein the at least two types of objects comprise a first type of object and a second type of object; and
determining the target area based on a corresponding area of the first type of object in response to a priority of the first type of object being greater than a priority of the second type of object.

4. The method according to claim 2, wherein said determining the point of interest of the image according to the target area, comprises:
determining the point of interest of the image based on a center point of the target area; or
determining the point of interest of the image based on any pre-set feature point of the target area.

5. The method according to claim 3, wherein said determining the point of interest of the image according to the target area, comprises:
determining the point of interest of the image based on a center point of the target area; or
determining the point of interest of the image based on any pre-set feature point of the target area.

6. The method according to claim 1, wherein said determining the target area in the image by detecting the image, comprises:
obtaining a salient area by detecting the image based on a visual saliency detection algorithm; and
determining the target area based on the salient area.

7. The method according to claim 6, wherein said obtaining the salient area by detecting the image based on a visual saliency detection algorithm, comprises:
obtaining gray values corresponding to different areas in the image by detecting the image based on the visual saliency detection algorithm; and
determining the salient area based on a first area corresponding to a first gray value, wherein the first gray value is within a pre-set gray value range.

8. The method according to claim 6, wherein said determining the point of interest of the image according to the target area, comprises:
obtaining a binary image corresponding to the salient area by binarizing the salient area; and determining the point of interest of the image based on a center of gravity of the binary image; or
obtaining cluster centers corresponding to the salient area by performing cluster analysis on the salient area; and determining the point of interest of the image based on a cluster center with a highest saliency degree among the cluster centers.

9. The method according to claim 1, wherein said processing the image according to the point of interest, comprises:
determining a cropping range according to the point of interest; and cropping the image according to the cropping range; or
determining a zooming center according to the point of interest; and zooming the image according to the zooming center; or
determining a translation start point and a translation end point according to the point of interest; and translating the image according to the translation start point and the translation end point.

10. An electronic device for image processing, comprising:
a processor; and
a memory configured to store executable instructions of the processor; wherein
wherein execution of the instructions causes the processor to:
determine a target area in an image by detecting the image, wherein the target area corresponds to a target image meeting a pre-set condition, and the image comprises the target image;
determine a point of interest of the image according to the target area; and
process the image according to the point of interest.

11. The electronic device according to claim 10, wherein the execution of the instructions further causes the processor to:
obtain at least one object of a same type by detecting the image based on an image recognition algorithm; and determine the target area based on a corresponding area of a target object, wherein the target object is an object with a highest priority among the at least one object of the same type.

12. The electronic device according to claim 10, wherein the execution of the instructions further causes the processor to:
obtain at least two types of objects by detecting the image based on an image recognition algorithm, wherein the at least two types of objects comprise a first type of object and a second type of object; and determine the target area based on a corresponding area of the first type of object in response to a priority of the first type of object being greater than a priority of the second type of object.

13. The electronic device according to claim 11, wherein the execution of the instructions further causes the processor to determine the point of interest of the image based on a center point of the target area; or determine the point of interest of the image based on any pre-set feature point of the target area.

14. The electronic device according to claim 12, wherein the execution of the instructions further causes the processor to determine the point of interest of the image based on a center point of the target area; or determine the point of interest of the image based on any pre-set feature point of the target area.

15. The electronic device according to claim 10, wherein the execution of the instructions further causes the processor to obtain a salient area by detecting the image based on a visual saliency detection algorithm; and determine the target area based on the salient area.

16. The electronic device according to claim 15, wherein the execution of the instructions further causes the processor to:
obtain gray values corresponding to different areas in the image by detecting the image based on the visual saliency detection algorithm; and determine the salient area based on a first area corresponding to a first gray value, wherein the first gray value is within a pre-set gray value range.

17. The electronic device according to claim 15, wherein the execution of the instructions further causes the processor to:
obtain a binary image corresponding to the salient area by binarizing the salient area; and determine the point of interest of the image based on a center of gravity of the binary image; or
obtain cluster centers corresponding to the salient area by performing cluster analysis on the salient area; and determine the point of interest of the image based on a cluster center with a highest saliency degree among the cluster centers.

18. The electronic device according to claim 10, wherein the execution of the instructions further causes the processor to:
determine a cropping range according to the point of interest; and crop the image according to the cropping range; or
determine a zooming center according to the point of interest; and zoom the image according to the zooming center; or
determine a translation start point and a translation end point according to the point of interest; and translate the image according to the translation start point and the translation end point.

19. A non-transitory computer readable storage medium carrying instructions thereon to be executed by a processor, wherein execution of the instructions causes the processor to:
determine a target area in an image by detecting the image, wherein the target area corresponds to a target image meeting a pre-set condition, and the image comprises the target image;
determine a point of interest of the image according to the target area; and
process the image according to the point of interest.

20. The non-transitory computer readable storage medium according to claim 19, wherein the execution of the instructions further causes the processor to:
obtain at least one object of a same type by detecting the image based on an image recognition algorithm; and
determine the target area based on a corresponding area of a target object, wherein the target object is an object with a highest priority among the at least one object of the same type.
